(19) United States
(12) Patent Application Publication
(10) Pub. No.: US 2014/0116625 A1
(43) Pub. Date: May 1, 2014

(54) PNEUMATIC TYPE HEAT SHRINK FILM APPLICATOR

(71) Applicant: XU YUAN PACKAGING TECHNOLOGY CO., LTD., Hsinchu County (TW)

(72) Inventor: NAN-YUAN HUANG, HSINCHU COUNTY (TW)

(73) Assignee: XU YUAN PACKAGING TECHNOLOGY CO., LTD., HSINCHU COUNTY (TW)

(21) Appl. No.: 13/661,229

(22) Filed: Oct. 26, 2012

(51) Int. Cl. B65C 9/26

(52) U.S. Cl. 156/510

(57) ABSTRACT

A pneumatic type heat shrink film applicator is provided, in which a bearing plate is provided on the frame body and sliding rails are provided at both sides of the bearing plate. A sliding block assembled on the bearing plate is in between the two sliding rails and a pneumatic cylinder is fixed on the bearing plate. An output shaft of the pneumatic cylinder is coupled to one end of the sliding block. A cutter unit opposite to the other end of the pneumatic cylinder is provided on the sliding block. In this manner, a heat shrink film can be cut quickly by the cutter unit driven by the speedy pneumatic cylinder and applied onto a container so as to expedite labeling operation of the heat shrink film.

### BACKGROUND OF THE INVENTION

1. Fields of the invention

The present invention relates to a pneumatic type heat shrink film applicator, more particularly to an efficient pneumatic type heat shrink film applicator in which a cutter unit is driven by a pneumatic cylinder, so that a heat shrink film can be cut quickly and then applied to a container.

2. Descriptions of Related Art

Generally, bottled or canned foods or beverages are usually wrapped with a heat shrink film on which product name, trademark, place of origin, instruction of use and advertisement words are printed so as to provide product identification for customers, to attract purchasing desire and to enhance sales appeal. When the heat shrink film is wrapped around the bottle caps, tamper-evident effect can be achieved, i.e., consumers can be aware whether the canned or bottled beverages or foods have been used or not by the presence or absence of tear of the shrink film wrapped around the bottle caps, so as to avoid purchase of used products.

### SUMMARY OF THE INVENTION

The present invention provides a pneumatic type heat shrink film applicator, in which a bearing plate is provided on a frame body and sliding rails are provided at both sides of the bearing plate. A sliding block is assembled on the bearing plate between the two sliding rails and a pneumatic cylinder is fixed on the bearing plate, and an output shaft of the pneumatic cylinder is coupled to one end of the sliding block. A cutter unit opposite to the other end of the pneumatic cylinder is provided on the sliding block.

Whereby, a heat shrink film can be cut quickly by the cutter unit driven by the speedy pneumatic cylinder and applied onto a container so as to expedite labeling operation of the heat shrink film and thus to increase production capacity.

### BRIEF DESCRIPTION OF THE DRAWINGS

FIG. 1 is a perspective view of the present invention.

FIG. 2 is a partially enlarged front view of the present invention.

FIG. 3 is a view showing the state of film delivery of the present invention.

FIG. 4 is a view showing the state of film guiding of the present invention.

FIG. 5 is a view showing the state of film cutting of the present invention.

FIG. 6 is a view showing the state of film developing of the present invention.

FIG. 7 is a view showing the state of film pushing of the present invention.

### DETAILED DESCRIPTION OF THE PREFERRED EMBODIMENT

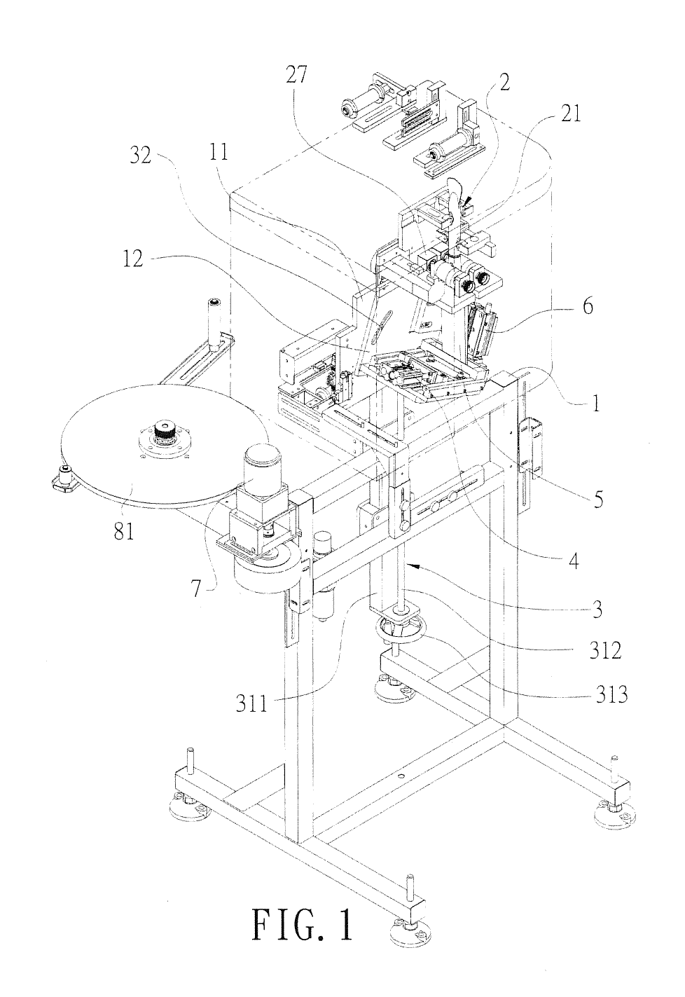

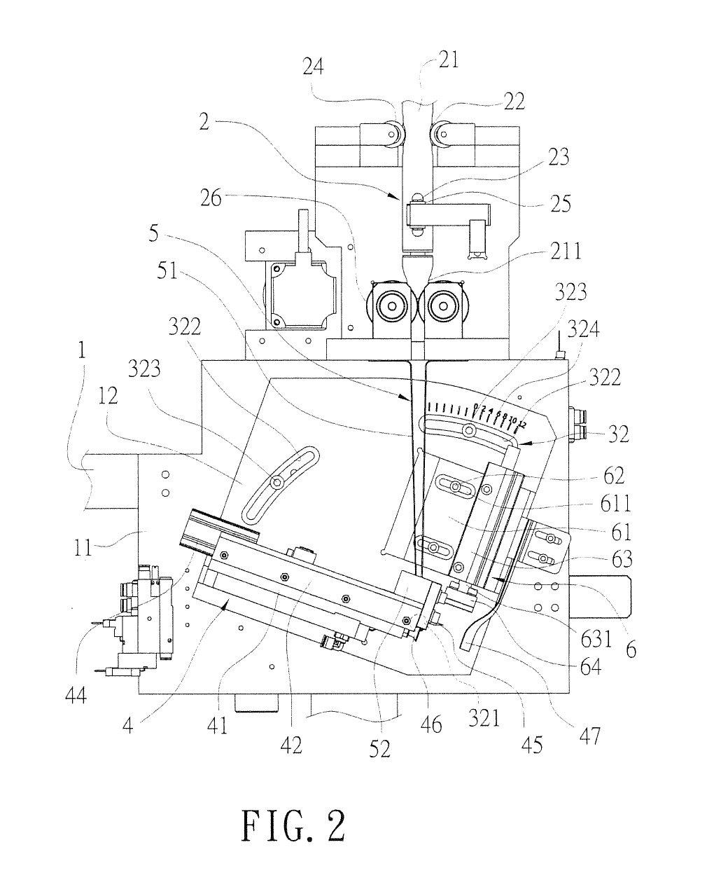

Firstly, referring to FIGS. 1 and 2, the pneumatic type heat shrink film applicator of the present invention is provided on its frame body (1) with a film delivery unit (2), an adjusting unit (3), a film developing and cutting unit (4), a film guiding unit (5) and a film pushing unit (6).

The frame body (1) includes an assembly plate (11) located at the upper part and provided to be separate from the frame body (1), and a major frame plate (12) in front of the assembly plate (11) and disposed with a tilt angle thereto.

The film delivery unit (2), including a cylindrical guide member (21), is provided on the assembly plate (11) of the frame body (1). Two first guide wheels (22) opposite to each other are provided separately at both sides of the guide member (21) and the guide member (21) is disposed to be beneath the two first guide wheels (22). Further, two second guide wheels (23) opposite to each other and installed to be staggered in 90 degrees with respect to the two first guide wheels (22) are also provided separately at both sides of the guide member (21). A first roller (24) and a second roller (25) are separately provided at lateral sides of the first and the second guide wheels (22), (23) and are abutted therewith. Two arc surfaces (211) gradually shrinking from two sides towards center point are formed at the bottom end portion of the guide member (21), and two major rollers (26) for abutting with the two arc surfaces (211) are separately provided on the assembly plate (11) of the frame body (1) at lateral sides of the two arc surfaces (211) of the guide member (21). The two major rollers (26) are respectively coupled to the transmission shafts of rotating power sources (27).

The adjusting unit (3) includes a lift adjusting unit (31) and a tilt adjusting unit (32). The lift adjusting unit (31) is provided with a support (311) the upper end of which is combined to the assembly plate (11), and a screw rod (312) in thread engagement with a threaded member disposed on the support (311) is provided on the frame body (1). A hand wheel (313) is provided at the bottom end of the screw rod (312). On the other hand, the tilt adjusting unit (32) is arranged between the assembly plate (11) of the frame body (1) and the major frame plate (12), the tilt adjusting unit (32) including a pivot (321) extending between the major frame plate (12) and the assembly plate (11), and an arc shape slot (322) provided on the major frame plate (12). A fastening member (323) penetrates through the arc shape slot (322) of the major frame plate (12) to be fastened on the assembly plate (11). Further, a scale (324) is provided along the arc shape slot (322) of the major frame plate (12).

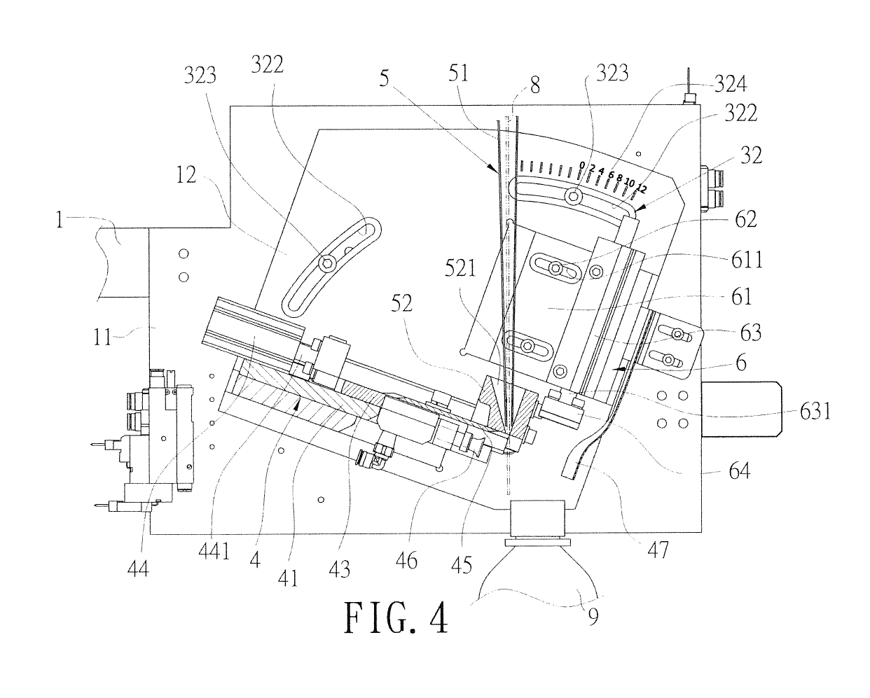

The film developing and cutting unit (4), as shown in FIG. 4, is mounted on the major frame plate (12). The film developing and cutting unit (4) includes a bearing plate (41) vertically assembled on the major frame plate (12). Two sliding rails (42) are separately provided at both sides of the bearing plate (41) and a sliding block (43) are provided between the two sliding rails (42). A pneumatic cylinder (44) is fixedly mounted on the bearing plate (41), and an output shaft (441) of the pneumatic cylinder (44) is coupled to one end of the sliding block (43). A cutter unit (45) opposite to the other end of the pneumatic cylinder (44) is provided on the upper end face of the sliding block (43), and a vacuum sucker (46) corresponding to the cutter unit (45) is provided on the bottom end face of the sliding block (43) and is connected to a vacuum machine. Further, the major frame plate (12) is provided with an arc guide sheet (47) opposite to the vacuum sucker (46).

The film guiding unit (5) includes two guide plates (51) assembled on the assembly plate (11). The two guide plates (51) are located below the guide member (21) of the film delivery unit (2), and the guide member (21) is positioned between the two guide plates (51) which are both gradually tapered in downward direction. A film hopper (52) located between the two sliding rails (42) of the film developing and cutting unit (4) is assembled above the cutter unit (45), and the bottom ends of the two guide plates (51) are placed into an opening (521) of the film hopper (52).

The film pushing unit (6) is assembled on the major frame plate (12) and is located above the film developing and cutting unit (4). The film pushing unit (6) has an adjusting plate (61) and a slot (611) is provided on the adjusting plate (61). A fastening member (62) passes through the slot (611) and is fastened with the major frame plate (12). A pneumatic cylinder (63) is further assembled on the adjusting plate (61) and a push plate (64) is coupled to an output shaft (631) of the pneumatic cylinder (63). The push plate (64) is located between the arc guide sheet (47) of the film developing and cutting unit (4) and the vacuum sucker (46).

During implementation, referring to FIGS. 1 and 2, the height of the pneumatic type heat shrink applicator of the present invention is adjusted according to the height of a container (9) to be applied with label. When the height of the pneumatic type heat shrink applicator is being adjusted, users grip and rotate the hand wheel (313) of the lift adjusting unit (31) so as to rotate the screw rod (312). Then, by thread engagement with the threaded member on the support (311), the assembly plate (11) assembled on the support (311) and the film delivery unit (2), the film developing and cutting unit (4), the film guiding unit (5) and the film pushing unit (6) are driven to lift up synchronously, so as to carry out the corresponding height adjustment in response to the height adjustment of the container (9). Then, users conduct angle adjustment of the film developing and cutting unit (4), the film guiding unit (5) and the film pushing unit (6) according to the position on the container (9) to be applied with film sleeve such as the major body or bottle cap of the container (9). This angle adjustment during implementation will be described as below. The fastening member (323) locked between the arc shape slot (322) of the major frame plate (12) and the assembly plate (11) is released so that the major frame plate (12) and the film developing and cutting unit (4), the film guiding unit (5) and the film pushing unit (6) mounted thereon can be rotated to required angle synchronously by taking the pivot (321), by which the major frame plate (12) and the assembly plate (11) is pivotally connected with each other, as the rotation center. In this manner, a label of a heat shrink film (8) can be applied accurately onto the location of the major body or bottle cap of the container (9). Moreover, the tilt angle adjustment of the major frame plate (12) can be done according to the scale (324) provided on the major frame plate (12) along the arc shape slot (322). After the required angle is adjusted, users can lock up the released fastening member (323) so as to fix the adjusted angle of the major frame plate (12) and the film developing and cutting unit (4), the film guiding unit (5) and the film pushing unit (6) mounted thereon.

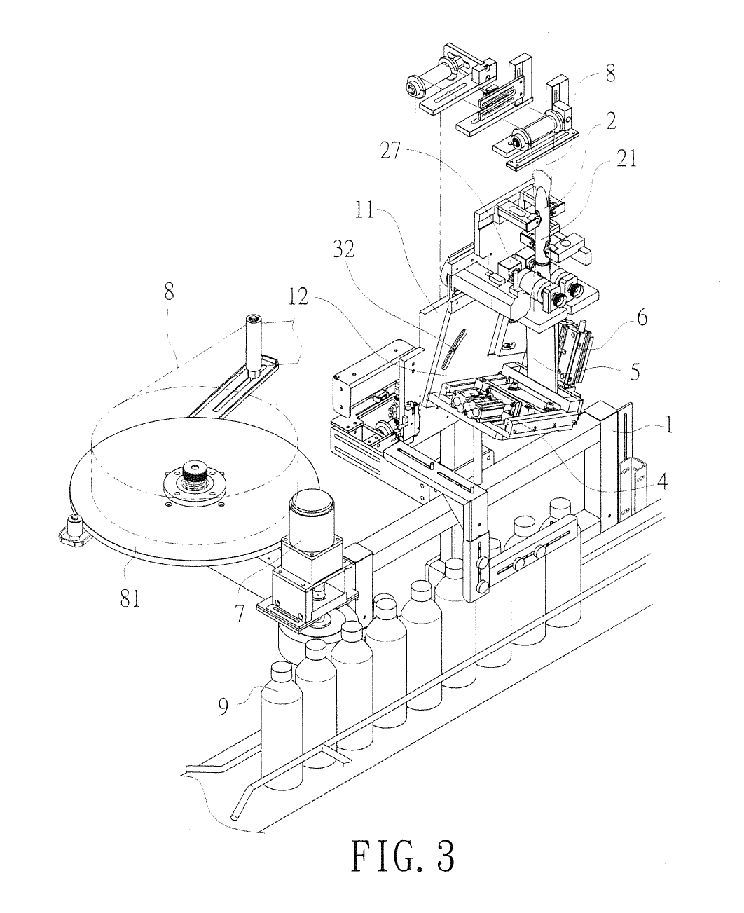

In turn, referring to FIG. 3, users firstly insert the heat shrink film (8) disposed on a shrink film rotating disc (81) of the frame body (1) into the guide member (21) of the film delivery unit (2), so that the shrink film (8) can reach the place between the first and the second rollers (24), (25) at the lateral sides of the first and the second guide wheels (22), (23), even the place between the arc surface (211) provided at the bottom end of the guide member (21) and the major roller (26). Then, the container (9), such as bottle or can, to be applied with label is transported in the direction of rails of the frame body (1) by a bottle conveying machine (7), so that the container (9) to be applied with label passes by through the bottom of the pneumatic type heat shrink film applicator of the present invention. Simultaneously, the rotating power source (27) having a major roller (26) assembled therewith drives the major roller (26) to rotate. The major roller (26) in rotating and the arc surface (211) abutting with the bottom end portion of the guide member (21) are designed in such a manner that the heat shrink film (8) located between the major roller (26) and the arc surface (211) of the guide member (21) is pulled to be fed forward. The stability of the feeding of the heat shrink film (8) can be further increased by the guiding of the first and the second guide wheels (22), (23) provided on the guide member (21) of the film delivery unit (2) and the first and the second rollers (24), (25).

Referring to FIG. 4, accompanying with the feeding by the film delivery unit (2), the heat shrink film (8) is fed to the film guiding unit (5) under the film delivery unit (2), passing through between the two guide plates (51) of the film guiding unit (5), following the guiding of the two guide plates (51) and reaching the film hopper (52) disposed between the two sliding rails (42) at both sides of the film developing and cutting unit (4). Under the guiding of the film guiding unit (5), the heat shrink film (8) can be delivered smoothly to a cutter unit (45) of the film cutting unit (4) and the upper side of the vacuum sucker (46).

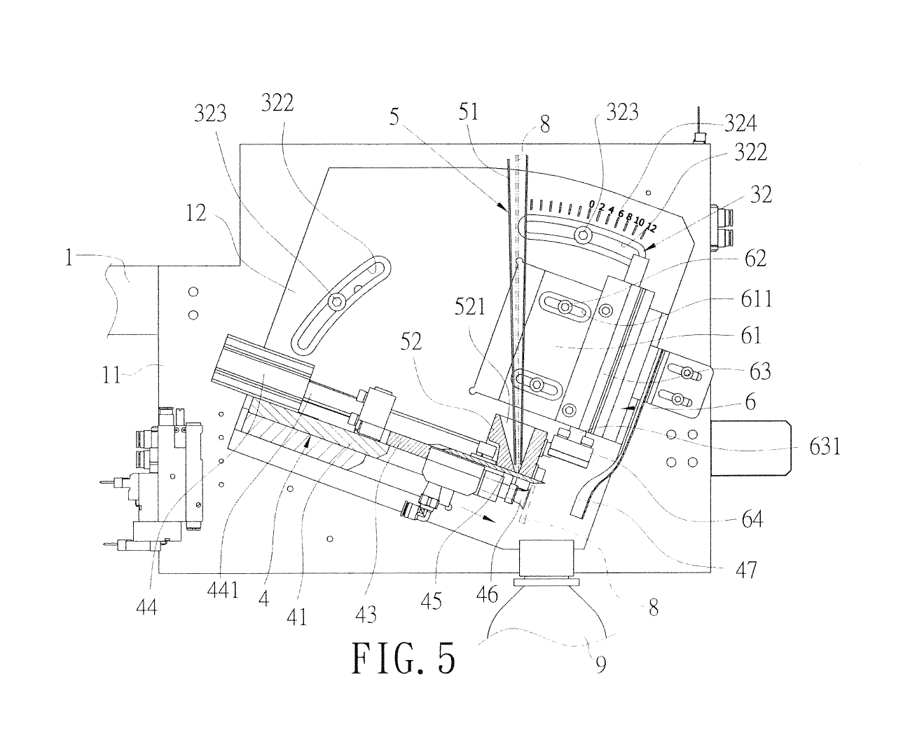

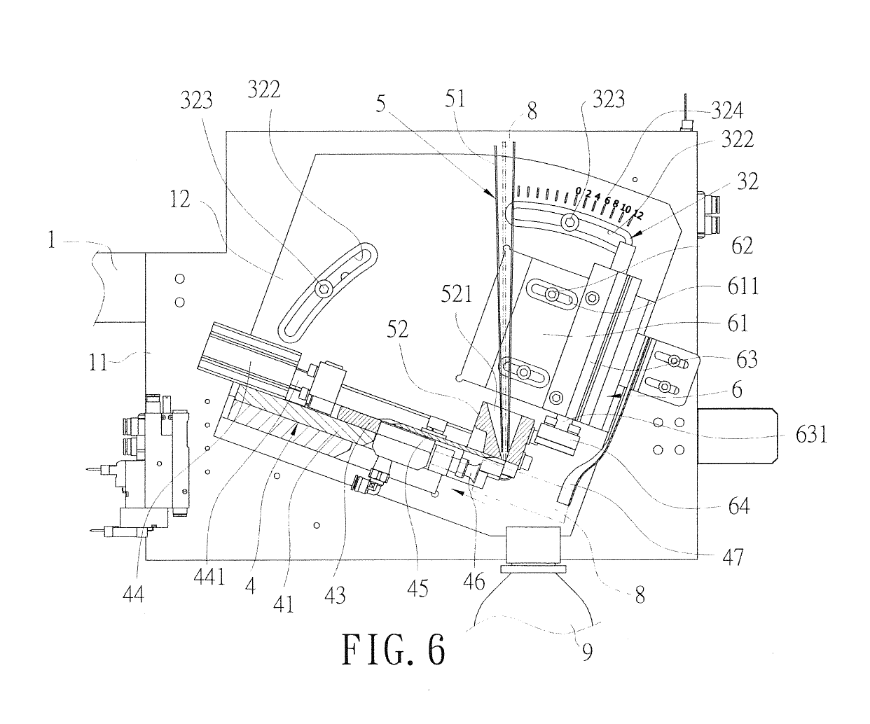

Referring to FIG. 5, when the heat shrink film (8) is delivered to the cutter unit (45) of the film cutting unit (4) and the upper side of the vacuum sucker (46), the pneumatic cylinder (44) of the film developing and cutting unit (4) drives, via the sliding block (43), the cutter unit (45) assembled on the upper and the lower end faces of the sliding block (43) and the vacuum sucker (46) to reciprocate, so that the heat shrink film (8) is firstly cut by the upper cutter (45). Referring to FIG. 6, the heat shrink film (8) falling down due to cutting is in turn sucked by the vacuum sucker (46) provided underneath. When one side of the heat shrink film (8) is sucked by the vacuum sucker (46), the other side of the heat shrink film (8) is also sucked, due to electrostatic action, by the arc shape guide sheet (47) of the major frame plate (12) provided oppositely to the vacuum sucker (46). The heat shrink film (8) herein can be developed under the sucking of the vacuum sucker (46).

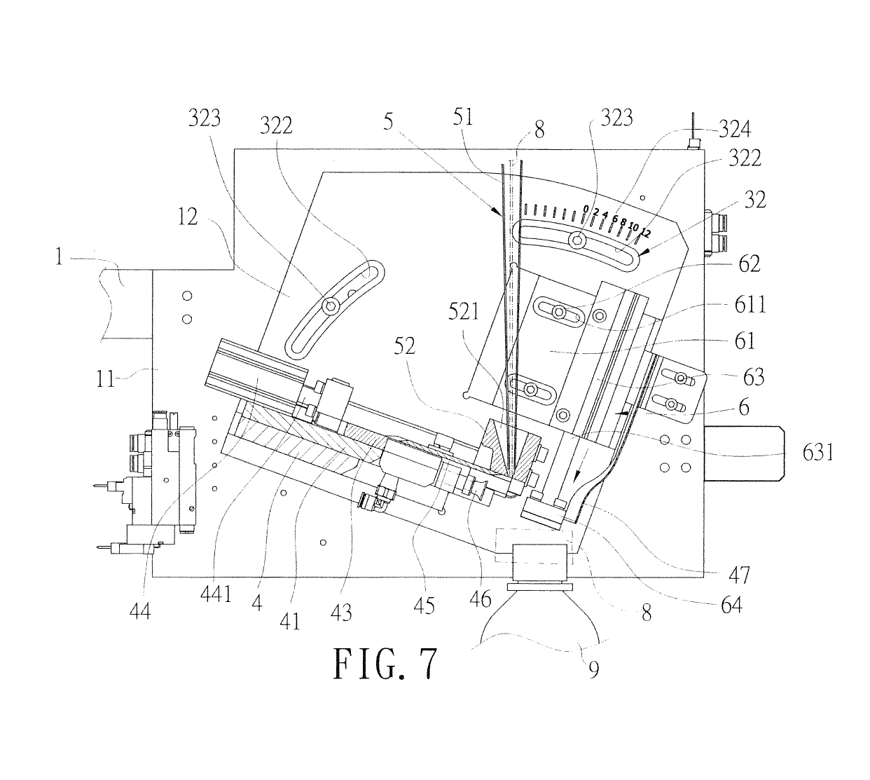

Next, referring to FIG. 7, the push plate (64) of the film pushing unit (6), provided above the film developing and cutting unit (4), is pushed by the pneumatic cylinder (63) towards the place between the arc shape guide sheet (47) and the vacuum sucker (46). Accompanying with the push action from the push plate (64), the heat shrink film (8) sucked and developed between the arc shape guide sheet (47) and the vacuum sucker (46) is applied onto the major body or bottle cap of the container (9) passing underneath, so that the operation of applying the heat shrink film (8) onto the container (9) can be accomplished conveniently and quickly. Then, the pneumatic cylinder (63) of the film pushing unit (6) and the pneumatic cylinder (44) of the film developing and cutting unit (4) drives separately to restore the push plate (64), the cutter unit (45) and the vacuum sucker (46) to their original positions, so as to be ready for the next cutting and applying operation of the heat shrink film (8).

What is claimed is:

1. A pneumatic type heat shrink film applicator, in which a frame body is provided and a film developing and cutting unit is disposed on said frame body, said film developing and cutting unit including a bearing plate assembled on said frame body and sliding rails being provided at both sides of said bearing plate; a sliding block being assembled on said bearing plate between said two sliding rails; a pneumatic cylinder being fixed on said bearing plate and an output shaft of said pneumatic cylinder being coupled to one end of said sliding block; a cutter unit opposite to the other end of said pneumatic cylinder being provided on said sliding block.

2. The pneumatic type heat shrink film applicator as claimed in claim 1, wherein said cutter unit of said film developing and cutting unit is provided on the upper end face of said sliding block, and a vacuum sucker corresponding to said cutter unit is provided on the bottom end face of said sliding block and is connected to a vacuum machine; a major frame plate is further provided with an arc guide sheet opposite to said vacuum sucker.

3. The pneumatic type heat shrink film applicator as claimed in claim 2, wherein said pneumatic type heat shrink film applicator further comprises a film pushing unit located above said film developing and cutting unit, said film pushing unit including a pneumatic cylinder assembled on said frame body and a push plate being fixed on an output shaft of said pneumatic cylinder, said push plate being positioned between said arc shape guide sheet and said vacuum sucker.

4. The pneumatic type heat shrink film applicator as claimed in claim 3, wherein said film pushing unit further includes an adjusting plate and a slot is provided on said adjusting plate, a fastening member being provided to pass through said slot so as to lock with said frame body, said pneumatic cylinder and said push plate combined thereon being assembled on said adjusting plate.

5. The pneumatic type heat shrink film applicator as claimed in claim 3, wherein said pneumatic type heat shrink film applicator further comprises a film delivery unit, said film delivery unit including a guide member combined to said frame body, a plurality of guide wheels being provided on said guide member, said plural guide wheels being guided to move along said guide member and being installed to be staggered in 90 degrees with each other; rollers being separately provided at lateral sides of said guide wheels and being abutted therewith; two arc surfaces shrinking from two sides towards center point being further formed at the bottom end portion of said guide member, and two major rollers for abutting with said two arc surfaces being separately provided on said frame body at lateral sides of said two arc surfaces of said guide member; said two major rollers being respectively coupled to the transmission shafts of rotating power sources.

6. The pneumatic type heat shrink film applicator as claimed in claim 5, wherein said pneumatic type heat shrink film applicator further comprises a film guiding unit, said film guiding unit including two guide plates combined on an assembly plate, said two guide plates being located below said guide member of said film delivery unit and said guide member being positioned between said two guide plates which are both tapered in downward direction; a film hopper located between said two sliding rails of said film developing and cutting unit being located above said cutter unit.

7. The pneumatic type heat shrink film applicator as claimed in claim 6, wherein said pneumatic type heat shrink film applicator further includes a lift adjusting unit, said frame body further including said assembly plate provided to separate from said frame body, and said film delivery unit, said film developing and cutting unit, said film guiding unit, and said film pushing unit being assembled on said assembly plate, said lift adjusting unit being assembled between said frame body and said assembly plate.

8. The pneumatic type heat shrink film applicator as claimed in claim 7, wherein said lift adjusting unit includes a support the upper end of which is combined to said assembly plate; a screw rod in thread engagement with a threaded member disposed on said support being provided on said frame body; a hand wheel being provided at the bottom end of said screw rod.

9. The pneumatic type heat shrink film applicator as claimed in claim 6, wherein said pneumatic type heat shrink film applicator further includes a tilt adjusting unit, said frame body having said major frame plate, disposed with a tilt angle, located in front of said assembly plate, said film developing and cutting unit and said film pushing unit being assembled on said assembly plate, said tilt adjusting unit being assembled between said assembly plate and said major frame plate.

10. The pneumatic type heat shrink film applicator as claimed in claim 9, wherein said tilt adjusting unit further includes a pivot extending between said major frame plate and said assembly plate and an arc shape slot provided on said major frame plate; a fastening member being provided to pass through said arc shape slot so as to lock with said assembly plate, a scale being further provided along said arc shape slot of said major frame plate.
